(19) United States
(12) Patent Application Publication
(10) Pub. No.: US 2008/0289311 A1
(43) Pub. Date: Nov. 27, 2008

(54) Multi-purpose maintenance machine

(76) Inventors: Terry Greene, Scarborough (CA); Jiemin Wu, Markham (CA)

Correspondence Address: RICHES, MCKENZIE & HERBERT, LLP, SUITE 1800, 2 BLOOR STREET EAST, TORONTO, ON, M4W 3J5, CA

(21) Appl. No.: 12/081,228

(22) Filed: Apr. 11, 2008

Related U.S. Application Data
(60) Provisional application No. 60/907,667, filed on Apr. 13, 2007.

(51) Int. Cl. A01D 34/00

(52) U.S. Cl. 56/255; 280/29; 296/187.01; 37/246

(57) ABSTRACT

A multi-purpose maintenance machine having interchangeable units to perform different maintenance functions such as: lawn mowing; lawn aerating; dethatching; lawn seeding and/or fertilizing; salt spreading; and snow blowing/throwing. The machine has a frame on four wheels and an exchangeable maintenance component has arms which are slidably received in slots. Different maintenance components perform different maintenance functions. A drive shaft is inserted in an axial bore of the component to engage the component and a sun gear so that rotates the component. The sun gear is rotated by an electric motor.

### RELATED APPLICATION

This application claims the benefit under 35 U.S.C. 119(e) to U.S. Provisional Patent Application Ser. No. 60/907,667, entitled “Multi-Purpose Maintenance Machine”, filed Apr. 13, 2007.

### FIELD OF THE INVENTION

This invention relates to a multi-purpose maintenance machine which has interchangeable units capable of performing different maintenance functions. More particularly, the present invention relates to a multi-purpose outdoor maintenance machine capable of performing the following functions: lawn mowing; lawn aerating; dethatching; lawn seeding and/or fertilizing; salt spreading; and snow blowing/throwing, etc.

### BACKGROUND OF THE INVENTION

Lawn mowing machines are known. In particular, a reel or cylindrical mower is known which consists of a device having one or more revolving blades used to cut grass or other plants at an even length. Generally, the reel mower has a set of spiral-cylindrical blades spinning on a horizontal axis. Cutting is by a scissor-like action between the moving spiral blades and a single stationary horizontal blade, or “bed knife”. The axle is attached to a gear that is then mounted on one of the wheels in order to spin the blades rapidly for good grass cutting action even when the mower is moving slowly. Reel mowers are usually not powered by a motor but rather turn with the turning of the wheels as the mower is pushed by a user.

Snow throwers are also known. Snow throwers consist of a machine for removing snow from an area where it is not wanted, such as a driveway, sidewalk, roadway or runway. Conventional snow throwers can use either electric power or a gasoline or diesel engine. Single stage snow throwers use a single high-speed impeller to both move the snow into the machine and force it out through a discharge chute. The impeller is usually in the form of two or more curved plastic paddles that move snow towards the centre line of the machine where the discharge chute is located.

However, the known lawn mowers and snow throwers are separate machines designed to perform the different seasonal maintenance functions.

A device which can be used as a lawn edger and alternately as a snow thrower is also known. A head part of the device capable of performing a lawn edging function is interchangeable with a head of the device capable of performing a snow throwing function. The interchangeable head is attached at an end of a handheld wand. However, such a device is limited in the amount of power which can be provided as it is merely a handheld wand. Also, such a device is not designed to function as a lawn mower, lawn aerator, salter/sander, fertilizer spreader or lawn seeder. Rather, the known device is also limited in its application to merely provide lawn edging and snow blowing functions.

Furthermore, this device is not suitably equipped to act as a snow “blower” and is merely a snow “thrower”. Thus, the device is limited in its application to removal of snow from smaller areas and areas which are covered with less snow.

The applicant has appreciated that providing a single device with exchangeable units capable of performing different maintenance functions such as lawn mowing, lawn aerating, dethatching, lawn seeding and/or fertilizing, salt spreading, and snow blowing/throwing results in a savings in terms of storage space which would otherwise be required to store the different machines. Furthermore, financial savings can be realized by providing one machine with the various interchangeable units as only the different interchangeable units are required to be purchased to perform different functions.

### SUMMARY OF THE INVENTION

Accordingly, it is an object of the present invention to at least partially overcome the disadvantages of the prior art. Also, it is an object of this invention to provide a multi-purpose maintenance machine having interchangeable units capable of performing different maintenance functions thereby reducing the costs associated with purchasing the various different machines to perform the different functions, for example a lawn mower, a snow blower, a dethatcher, etc. Because all of these functions can be performed by the multi-purpose maintenance machine of the present invention, a significant cost savings can be achieved.

It is a further object of this invention to provide a multi-purpose maintenance machine that is simplified in its construction and easy to manufacture and maintain. It is also an object to provide simple means to change between maintenance functions performed by the machine. By providing functional modular heads, the same frame, same driving power and same driving mechanics can be used as an all-in-one machine to perform different maintenance functions.

In one aspect, the present invention resides in a multi-purpose maintenance machine having: a machine body which is able to be manipulated by a user and adapted to receive an interchangeable unit having a specific maintenance function. More particularly, the interchangeable unit is selected from the group consisting of: a lawn mowing device, an aerating device, a dethatching device, a seeding device, a fertilizer spreading device, a snow blowing device, and a salter and/or sand spreading device.

In another aspect, the present invention resides in a multi-purpose maintenance machine having a wheeled body which is able to be manipulated by a user and adapted to receive an interchangeable unit having an outdoor maintenance function.

In another aspect, the present invention resides in a multi-purpose outdoor maintenance machine having: a body having a first side and a second side elongated between a front end and a rear end of the body, the first side having a first slot open towards the front end, and the second side having a second slot open towards the front end; a modular working member having first and second arms fitted into the respective first and second slots, the modular working member having a rotatable shaft; a handle fixed to the rear end of the body for manipulation by a user; and a motor to rotate the shaft of the modular working member.

In a further aspect, the present invention resides in an interchangeable modular unit for a wheeled multi-purpose maintenance machine, the interchangeable unit having an apparatus configured for an outdoor maintenance function. More particularly, the apparatus is selected from the group consisting of: a lawn mowing device, an aerating device, a dethatching device, a seeding device, a fertilizer spreading device, a snow blowing device, and a salter and/or sand spreading device.

Further and other features of the invention will be apparent to those skilled in the art from the following detailed description of the embodiments thereof.

### BRIEF DESCRIPTION OF THE DRAWINGS

Reference may now be had to the following detailed description taken together with the accompanying drawings in which:

FIG. 1 shows a perspective view of the multi-purpose maintenance machine;

FIG. 2 is a top view of the multi-purpose maintenance machine of FIG. 1;

FIG. 3 is an end view of a multi-purpose maintenance machine shown in FIG. 1;

FIG. 4 is a sectional view taken along section C-C in FIG. 3;

FIG. 5 is a side view of the multi-purpose maintenance machine of FIG. 1;

FIG. 6 is a perspective view of the multi-purpose maintenance machine of FIG. 1 including a user handle;

FIG. 7 shows a perspective view of a multi-purpose maintenance machine adapted as a snow thrower in accordance with another embodiment of the present invention;

FIG. 8 shows the multi-purpose maintenance machine of FIG. 7 with a modular working member snow thrower cartridge uninstalled;

FIG. 9 shows a front view of the multi-purpose maintenance machine of FIG. 7;

FIG. 10 shows a cross-sectional view through line A-A in FIG. 9;

FIG. 11 shows the snow thrower cartridge shown in FIG. 8;

FIG. 12 shows a perspective view of the multi-purpose maintenance machine shown in FIG. 7 adapted as a lawn mower;

FIG. 13 shows a bottom view of the multi-purpose maintenance machine of FIG. 12;

FIG. 14 shows a perspective view of a modular working member lawn mower unit;

FIG. 15 shows a perspective view of a modular working member aerator/dethatcher unit; and

FIG. 16 shows a perspective view of a modular working member for carrying out lawn seeding and/or fertilizing or salt and/or sand spreading.

### DETAILED DESCRIPTION OF THE PREFERRED EMBODIMENTS

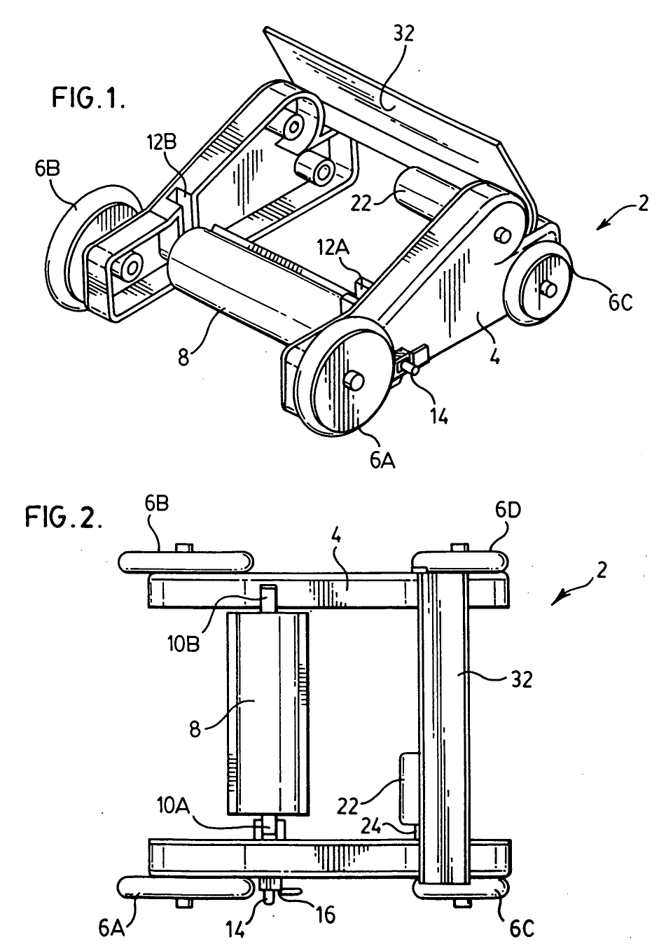

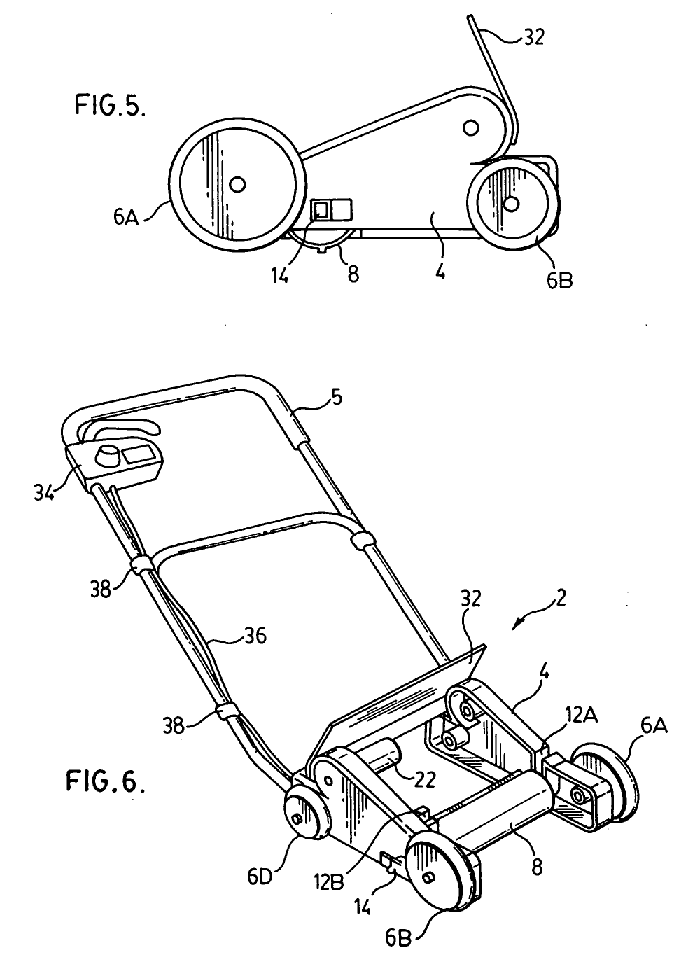

Reference is first made to FIG. 1 which illustrates, in perspective view, the multi-purpose maintenance machine 2. The multi-purpose maintenance machine 2 comprises a frame 4 movable on four wheels 6A, 6B, 6C and 6D. A user handle 5 is shown in FIG. 6 and will be discussed in more detail with reference to FIG. 6 hereafter.

The multi-purpose maintenance machine 2 is advantageously capable of carrying out various maintenance features, for example lawn mowing, lawn aerating, dethatching, lawn seeding and/or fertilizing, salt spreading, and snow blowing/throwing, etc. These maintenance functions are provided by a removable component 8. As shown, the removable component 8 has arms 10A and 10B at opposite ends thereof that are slidably removably insertable into slots 12A, 12B provided on the frame 4. As shown in FIGS. 1 and 2, the removable component 8 is capable of performing snow throwing functions and is substantially cylindrical with the arms 10A, 10B being axially disposed at either end of the cylindrical removable component 8 substantially through a longitudinal axis of the removable component 8.

As shown in FIGS. 1 and 2, a removable drive shaft 14 is insertable through an aperture 16 at one side of the frame 4. The removable drive shaft 14 is positioned through an interior bore in the arms 10A and 10B, the bore having a cross-sectional shape, for at least a portion thereof, which corresponds to the cross-sectional shape of the removable drive shaft 14. Thus, when the drive shaft 14 is rotated, a corresponding rotation is translated to the removable component 8. Preferably, mechanical ball or roller bearings (not shown) are positioned on the arms 10A and 10B, so that an outer race of the bearings is engaged against an inner circumference of the slots 12A and 12B, respectively. The inner race is engaged on the arms 10A and 10B. Thus, the removable component 8 rotates on the bearings.

The removable drive shaft 14 also passes through a central opening 18 in a component pulley 20. The central opening 18 as shown in the sectional view of FIG. 4 has a square, or slotted profile such that a corresponding square or slotted profile of the removable shaft 14 engages the component pulley 20. Thus, when the component pulley 20 is rotated, the removable drive shaft 14 is correspondingly rotated to provide rotational movement to the removable component 8, for example to facilitate the snow throwing function. Preferably, the shaft 14 is rotated at approximately 3500 revolutions per minute.

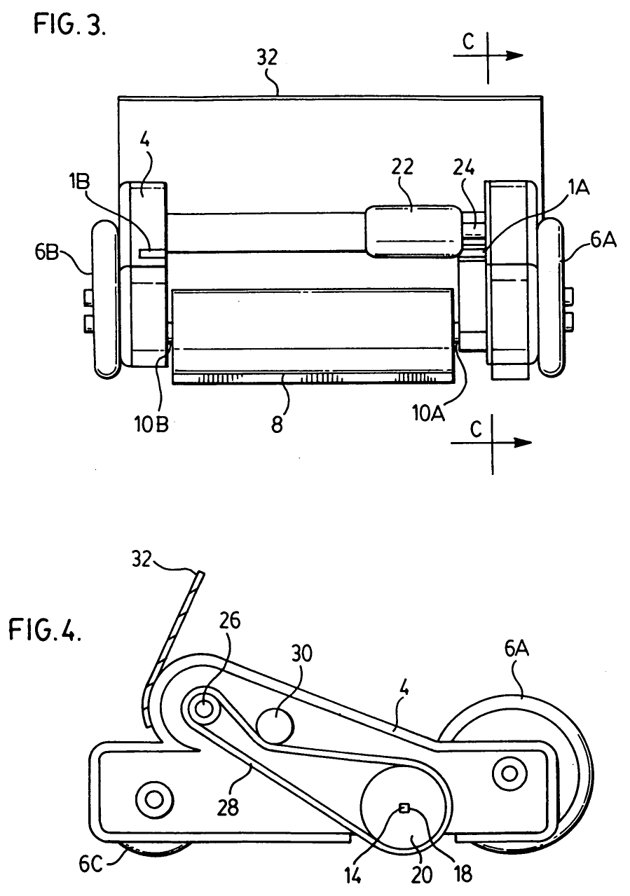

To facilitate rotation of the component pulley 20, a drive motor 22 is mounted to the frame 4, as shown in FIG. 3. The motor can be either gas or diesel powered or electric and optionally powered by a battery. Preferably, the motor is capable of outputting 2 horse power. The drive motor 22 has a drive motor shaft 24 which engages a drive motor pulley 26, shown in FIGS. 3 and 4. The drive motor pulley 26 is mounted for rotation by the drive motor to in turn move the drive belt 28. The drive belt 28 is fitted around the drive motor pulley 26 and the component pulley 20. A belt tensioner 30 is optionally provided mating the drive pulley 28 tightly around the drive motor pulley 26 and component pulley 20.

A cover 32 is slidably disposed on the frame 4 to optionally enclose the inner space in the frame 4 of the multi-purpose maintenance machine 2, as shown in the drawings.

FIG. 6 shows the multi-purpose maintenance machine of FIG. 1 with a user handle 5. The user handle 5 is a U-shaped tubular member which is fastened to the frame 4 at each end of the U-shaped member. A user can manipulate the frame 4 to move on its wheels 6A, 6B, 6C and 6D via the handle 5.

A set of user controls 34 are fixed to the handle. The user controls 34 are electrically connected to the motor 22 by electrical wire 36. The wire 36 is fixed to the user handle 5 by fasteners 38. The user controls 34 are used to activate the motor 22 and turn the component 8 in a desired direction.

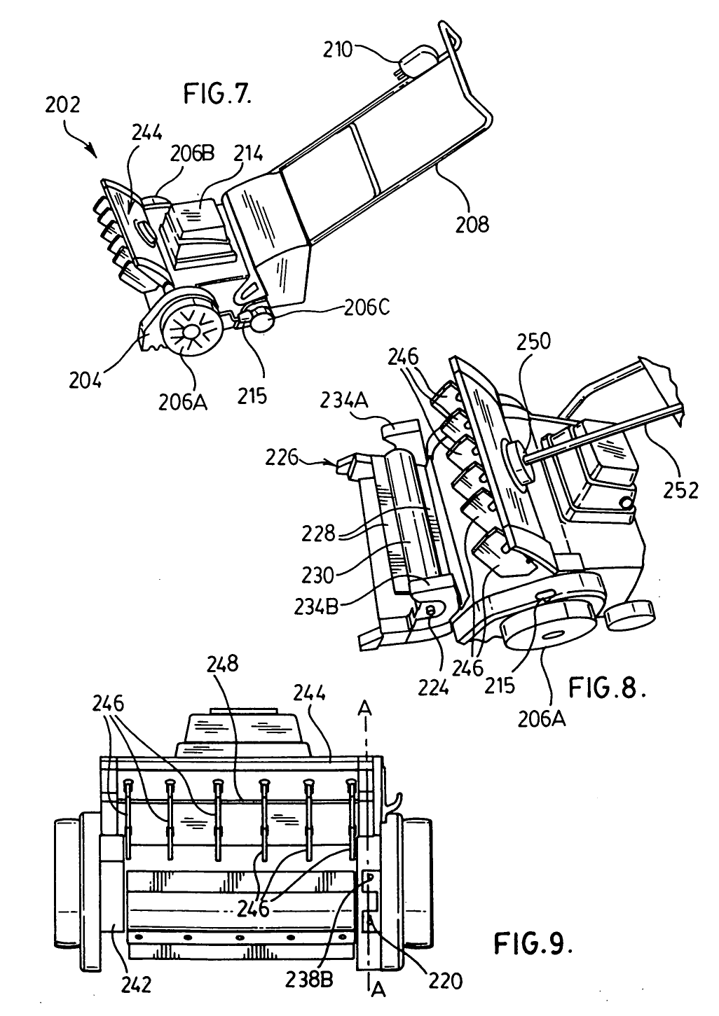

FIG. 7 shows a perspective view of a multi-purpose maintenance machine 202 adapted as a snow thrower in accordance with another embodiment of the present invention. The multi-purpose machine 202 has a machine frame or body 204 which is movable on four rotatable wheels 206A, 206B, 206C and 206D. A user handle 208 is fixed to a rear end of the body 204.

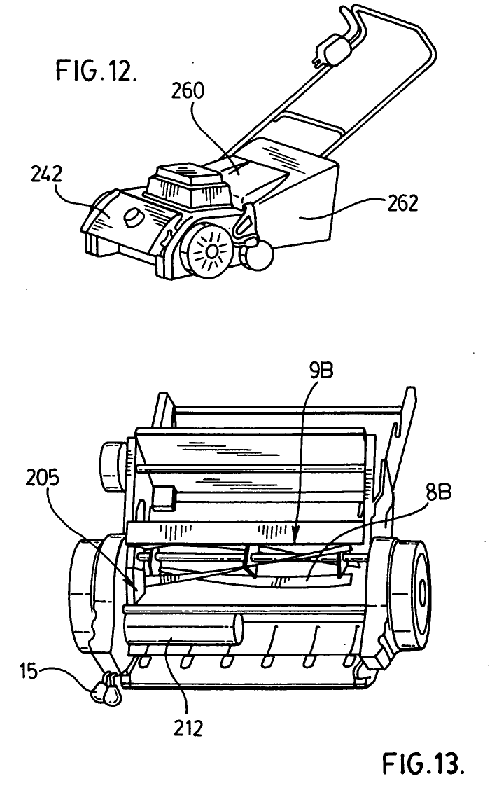

A user control 210 is provided on the handle 208. The user control 210 has a power switch to turn a DC motor 212 on or off. The motor 212 is shown in FIG. 12. The user control 210 also controls a direction of rotation of a shaft of the motor 212. The motor 212 is powered by a 12V lead-acid battery 214.

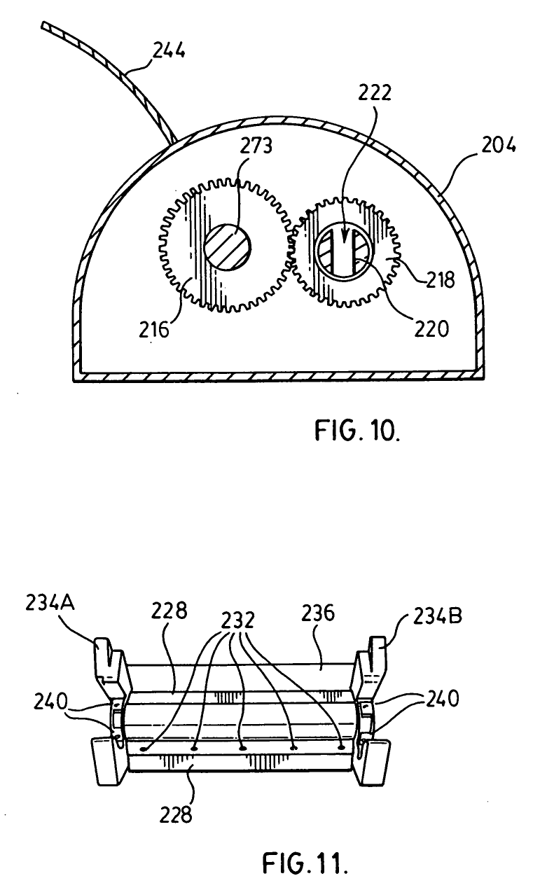

FIG. 10 shows a cross-sectional view through line A-A in FIG. 9. The motor 212 has a shaft 213 fixed to a motor gear 216. The motor gear 216 is turned by the shaft 213. The motor gear 216 reduces the rotating speed and increases the driving torque. A second gear 218 is rotatably fixed to the cover 205 as shown in FIG. 10. The second gear 218 has teeth which are positioned in mesh with teeth of the motor gear 216. Rotation of the motor gear 216 transmits rotation to the second gear 218.

A second gear shaft 220 is positioned at a centre of the second gear 218. The shaft 220 has a slot 222 which receives a flat end of a drive shaft 224 of an interchangeable functional cartridge 226. The drive shaft 224 has a flat end which fits into the slot 222 and the drive shaft 224 is correspondingly rotated by rotation of the second gear 218 to provide rotational movement to the interchangeable functional cartridge 226, for example to facilitate a snow throwing or lawn mowing function.

As shown in FIG. 12, the motor 212 is mounted to a cover 205. An adjustment lever 215 is provided to rotate the cover 205 about an inner wheel well of the wheel 206 A. By rotating the cover 205, the vertical and horizontal positioning of the drive shaft 224. For example, when the machine 202 is used for lawn mowing, the cartridge 263 is positioned closer to the front of the machine 202. The lever 215 is also used to adjust a height of the mowing blades to suit a user's preference. When the machine 202 is used for snow throwing, the cartridge 226 is moved to a position further back within the machine 202.

As shown in FIG. 8, the removable cartridge 226 is configured to carry out the snow throwing function. The snow throwing cartridge 226 is shown in detail in FIG. 10. Snow throwing blades 228 are fixed to rotatable cylinder 230 with screws 232. The rotatable cylinder 230 is fixed to the drive shaft 224 for rotation with the drive shaft. As such, the blades 228 rotate about an axis of the drive shaft 224.

The removable component 226 has lateral sides or arms 234A, 234B. A back plate 236 is fixed to the sides 234A and 234B, as shown in FIG. 10.

To attach the removable component 226 to the machine frame 204, the side arms 234A, 234B, are slidably received within respective slots 238A, 238B, as shown in FIG. 9. Once the cartridge 226 is inserted, it is fixed to the body 204 by cartridge securing screws 240, as shown in FIG. 10. Preferably, a cover 242 is fitted overtop of the screws 240, to keep snow and other debris from collecting within the recess where the screws 240 are fixed. The cover 242 is shown in FIG. 9.

A front cover assembly 244 is provided and is pivotable into open and closed positions. FIG. 7 shows the front cover 244 in an open position. The front cover assembly 244 has snow guiding blades 246 provided on an underside of the cover assembly 244. The snow guiding blades are pivotable on a snow guiding blade shaft 248 so that snow can be thrown either to the left side or right side of the multi-purpose machine 202 when used as a snow thrower.

As shown in FIG. 8, a snow guiding blade direction controller 250 is provided on a top surface of the front cover 244. A crank handle 252 is inserted into the controller 250 to effect the turning of the guiding blades 246 in the left or right direction. The crank handle 252 engages the controller 250 either by friction fit or as having a corresponding cross-sectional shape which has at least one face which meets with a corresponding cross-sectional shape within a bore hole of the controller 250.

The controller 250 has a threaded post which meshes with teeth circumferentially provided on the snow guide blade shaft 248, shown in FIG. 9. Rotating the crank handle 252 about its longitudinal axis rotates the controller 250 and moves the shaft 248 in either a left or right direction.

FIG. 12 shows the multi-purpose machine 202 configured as a lawn mower. The front cover 242 is in its closed position. A rear cover 260 is lifted to an open position and a collection bag 262 is fixed to a back end of the multi-purpose maintenance machine 202.

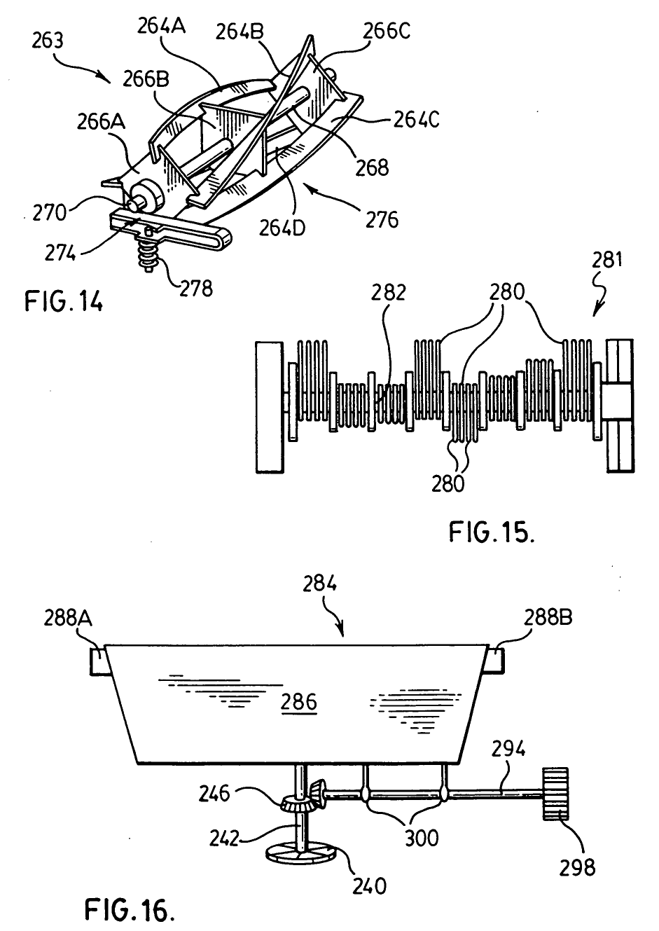

As shown in FIG. 14, the removable cartridge 263 comprises lawn mowing blades 264A, 264B, 264C and 264D. The blades 264A, 264B, 264C and 264D are positioned circumferentially around shaft 224 and spaced substantially equidistant. Positioning blades 226A, 226B and 226C are provided to secure the blades 264A, 264B, 264C and 264D at desired positions as shown in FIG. 14. A lawn mowing component shaft 268 is fixed to each of the plates 226A, 226B and 226C. A flattened end 270 is provided at one end of the shaft 268 to engage with the slot 222 of the second gear 218, as shown in FIG. 10.

As shown, the flattened end 270 of the shaft 268 extends through a mechanical ball or roller bearing 272 positioned on an arm 274 of the cartridge 263. An outer race of the bearing is engaged against the arm 274 and an inner race of the bearing is engaged against the shaft 268. As such, rotation of the shaft 268 in turn rotates the blades 264A, 264B, 264C and 264D about an axis of the shaft 268.

A fixed edge blade 276 is positioned below the set of cutting blades 264A, 264B, 264C and 264D. A spring 278 is provided to force the fixed edge plate 276 downward to a desired height, and to allow for undulations in a lawn which is being mowed.

FIG. 15 shows a removable cartridge 281 which carries out lawn aerating or dethatching functions. The cartridge 281 comprises a set of steel spring needles 280 which rotate about a shaft 282. The cartridge 281 is attached to the multi-purpose maintenance machine in the same manner as the snow throwing cartridge 226 and lawn mowing cartridge 263 described above.

FIG. 16 shows a movable cartridge 284 which is suited for carrying out lawn seeding and/or fertilizing, or salt/sand spreading. The cartridge 284 has a hopper 286 which is an open topped container into which seed, fertilizer, sand and/or salt can be added. Lateral arms 288A, 288B are provided at lateral sides of the hopper 286. The arms 288A, 288B engage with respective slots on a multi-purpose maintenance machine, as previously described, to attach the cartridge 284 to the machine.

A hole (not shown) is provided at a substantially central location of a bottom surface of the hopper 286. The seed, fertilizer, salt and/or sand disposed in hopper 286 is permitted to fall through the hole and onto a rotatable dispenser 290, disposed below the hole. The dispenser 290 is rotatably fixed to a bottom surface of the hopper 286 by a rotatable shaft 292. The rotatable shaft 292 is rotated by a drive shaft 294 having spiral gear teeth 296 which mesh with gear teeth provided spirally around the rotatable shaft 292. By this configuration, an axial rotation of the drive shaft 294 provides an to axial rotation of the shaft 292, and therefore the dispenser 290, orthogonal to the axial rotation of the drive shaft 294. A gear 298 is provided at an end of the drive shaft 294 which is opposite to the gear joint 296. The gear 298 engages teeth disposed on an inner circumference of a wheel drum of the multi-purpose maintenance machine (not shown). The drive shaft 294 is supported by posts 300 fixed to an underside of the hopper 286. As such, rotation of the drive shaft 294 is provided merely by the rotation of a wheel of the machine, and not by a motor.

In use, as the machine is moved, rotation of the wheel translates into rotation of the dispenser 290 to spread seed, fertilizer, salt and/or sand.

Although this disclosure has described and illustrated certain preferred embodiments of the invention, it is also to be understood that the invention is not restricted to these particular embodiments rather, the invention includes all embodiments which are functional, or mechanical equivalents of the specific embodiments and features that have been described and illustrated herein.

It will be understood that, although various features of the invention have been described with respect to one or another of the embodiments of the invention, the various features and embodiments of the invention may be combined or used in conjunction with other features and embodiments of the invention as described and illustrated herein.

What is claimed is:

1. A multi-purpose maintenance machine having:
a wheeled body which is able to be manipulated by a user and adapted to receive an interchangeable unit having an outdoor maintenance function.

2. The multi-purpose outdoor maintenance machine of claim 1, wherein the interchangeable unit is positioned at a front end of the wheeled body.

3. The multi-purpose outdoor maintenance machine of claim 1, wherein the interchangeable unit is positioned at a rear end of the wheeled body.

4. The multi-purpose outdoor maintenance machine of claim 1, wherein the interchangeable unit is fixed to the wheeled body by a friction fit.

5. The multi-purpose outdoor maintenance machine of claim 1, wherein the interchangeable unit is fixed to the wheeled body by mechanical fasteners.

6. The multi-purpose outdoor maintenance machine of claim 1, wherein a handle is fixed at a rear end of the body for manipulation by a user.

7. The multi-purpose outdoor maintenance machine of claim 1, wherein the interchangeable unit is selected from the group consisting of: a lawn mowing device, an aerating device, a dethatching device, a seeding device, a fertilizer spreading device, a snow blowing device, and a salter and/or sand spreading device.

8. A multi-purpose outdoor maintenance machine having:
a body having a first side and a second side elongated between a front end and a rear end of the body, the first side having a first slot open towards the front end, and the second side having a second slot open towards the front end;
a modular working member having first and second arms fitted into the respective first and second slots, the modular working member having a rotatable shaft;
a handle fixed to the rear end of the body for manipulation by a user; and
a motor to rotate the shaft of the modular working member.

9. The multi-purpose outdoor maintenance machine of claim 8, wherein the body is mounted on four wheels.

10. The multi-purpose outdoor maintenance machine of claim 8, wherein the slots are mounted to an adjustor assembly to position the interchangeable unit at a desired height.

11. The multi-purpose outdoor maintenance machine of claim 8, wherein the modular working member comprises at least one lawn mowing blade.

12. The multi-purpose outdoor maintenance machine of claim 8, wherein the modular working member comprises a snow throwing apparatus.

13. The multi-purpose outdoor maintenance machine of claim 8, wherein the modular working member comprises a lawn dethatching apparatus.

14. The multi-purpose outdoor maintenance machine of claim 8, wherein the modular working member is fixed to the body by friction fit.

15. The multi-purpose outdoor maintenance machine of claim 8, wherein the modular working member is fixed to the body with mechanical fasteners.

16. An interchangeable modular unit for a wheeled multi-purpose maintenance machine, the interchangeable unit having an apparatus configured for an outdoor maintenance function.

17. The interchangeable modular unit of claim 16, wherein the apparatus is selected from the group consisting of: a lawn mowing device, an aerating device, a dethatching device, a seeding device, a fertilizer spreading device, a snow blowing device, and a salter and/or sand spreading device.
